(19) United States
(12) Patent Application Publication
(10) Pub. No.: US 2006/0000530 A1
(43) Pub. Date: Jan. 5, 2006

(54) Pneumatic tire

(75) Inventor: Nobuyuki Hirai, Kodaira City (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo 104-8340 (JP)

(21) Appl. No.: 10/536,185

(22) PCT Filed: Nov. 25, 2003
(86) PCT No.: PCT/JP03/15042

§ 371 Date: May 24, 2005

(30) Foreign Application Priority Data
Nov. 25, 2002 (JP) 2002-341177

(51) Int. Cl. B60C 17/00; B60C 9/02; B60C 9/18; B60C 9/22; B60C 11/00; B60C 13/00; B60C 15/06; B60C 5/14; B60C 19/08; B60C 1/00

(52) U.S. Cl. 152/450; 152/526; 152/548; 152/510; 152/209.1; 152/525; 152/541; 156/130; 156/134; 152/209.5; 152/152.1; 152/531; 152/532; 152/543; 152/555; 152/517

(57) ABSTRACT

There is provided a pneumatic tire having considerably improved uniformity and balance, which comprises a radial carcass comprised of one carcass ply, a bead filler rubber arranged at an outer peripheral side of a bead core, an innerliner arranged at an inner face side of the carcass, a belt comprised of two belt layers, a tread rubber forming a treading face, and a side rubber arranged at an outer face side of a side portion of the carcass to form a sidewall of the tire, in which joints positioned at approximately equal intervals in the peripheral direction are arranged in each of the innerliner, the carcass ply and the belt layer, and joints positioned at intervals in a direction along an outer profile at a meridional section of the tire and extending substantially in the peripheral direction are arranged in each of the tread rubber, the bead filler rubber and the side rubber.

### TECHNICAL FIELD

This invention relates to a pneumatic tire built on a building drum having a basic form of substantially a cylinder, and particularly proposes a technique of largely improving a uniformity and a balance of the tire.

### BACKGROUND ART

In general, the conventional building of a green tire using a building drum is carried out by forming a green case comprised of an innerliner, a carcass, bead cores, side rubbers and the like on a building drum, transferring the green case onto another building drum, conducting a tire building so as to expand and deform a central portion of the green case in a radial direction, and affixing a previously formed belt-tread band onto an outer peripheral thereof.

When the green tire is built under the action of the building drums, if an innerliner material, carcass ply material, belt material, tread rubber material and the like each previously cut into given length and width are affixed on the building drum over a full periphery based on the rotating movement of the building drum at the green case forming step of arranging the innerliner, carcass ply side rubber and the like on the building drum and the belt-tread band forming step, an overlap joint portion between a start end portion and a terminal end portion of each material in affixing is necessarily produced at one place in the peripheral direction because the innerliner, carcass ply, side rubber and the like are continuously extended on the drum over full peripheries thereof. Further, there is no guarantee that such an overlap joint portion is equally dispersed in the peripheral direction of the building drum between these materials, so that even if a counter-measure for suppressing the increase of the thickness in the overlap joint portion is taken in each of the materials, it is unavoidable to necessarily lower the uniformity and the balance of a product tire produced by vulcanizing the green tire.

The invention is a subject matter to solve the problems inherent to the pneumatic tire produced by using the building drums, and an object thereof is to provide a pneumatic tire largely improving the uniformity and the mass balance.

### DISCLOSURE OF THE INVENTION

The pneumatic tire according to the invention comprises a carcass comprised of one or more carcass plies toroidally extending between a pair of bead cores and wound mostly at a side portion thereof around the bead core from an inside toward an outside in a widthwise direction of the tire and outward in a radial direction, a bead filler rubber arranged at an outer peripheral side of the bead core between a main body portion and a turnup portion of the carcass, an innerliner arranged at an inner face side of the carcass, a belt arranged on an outer peripheral side of a crown portion of the carcass and comprised of one or more belt layers, a tread rubber arranged on an outer peripheral side of the belt to form a treading face, a side rubber arranged on an outer face side of a side portion of the carcass to form a sidewall of the tire, in which at least one of the innerliner, the carcass ply and the belt layer is provided with a plurality of joints approximately equally positioned at approximately constant intervals in a peripheral direction through, for example, butt joining, overlap joining or the like, and at least one of the tread rubber, the bead filler rubber and the side rubber is provided with joints positioned at intervals in a direction along an outer profile in a meridional section of the tire and extending substantially in the peripheral direction.

According to the invention, the plurality of the joints through the overlap or butt joining existing in one or more layers of the innerliner, carcass ply and belt layer are equally and dispersedly positioned at the constant intervals in the peripheral direction, and these joints formed in each layer are sufficiently balanced statically and dynamically between the mutual joints, so that the joints in each layer can effectively contribute to the realization of excellent uniformity and high balance in the tire without considering the relative position of the joint between the one layer and the other layer and the like. This is particularly effective when the joints are arranged in all of the innerliner, the carcass ply and the belt layer at approximately constant intervals in the peripheral direction.

Furthermore, the joints extending substantially in the peripheral direction and positioned at approximately equal intervals are formed in one or more of the tread rubber, the bead filler rubber and the side rubber, whereby joints such as butt joint portions and the like extending in the meridional direction of the tire can be eliminated from one or more layers of the tread rubber, the bead filler rubber and the side rubber and hence the excellent uniformity and high balance in the tire can be realized. In this case, the joints in each rubber layer are formed substantially symmetrically with respect to an equatorial plane of the tire, whereby respective tire portions positioned across the equatorial plane can be made sufficiently homogeneous with each other.

This can become more remarkable by arranging the joints extending substantially in the peripheral direction in all of the tread rubber, the bead filler rubber an the side rubber.

It is advantageous to continuously arrange the joints in the innerliner substantially in the meridional direction of the tire for facilitating the formation of the joint and enhancing the balance between portions in a product tire positioned across the equatorial plane. This is true even in the carcass ply when the product tire is a radial tire and the carcass ply cord(s) extends substantially in the meridional direction of the tire.

When the joints are extended substantially in the meridional direction of the tire, the interval between the joints is gradually widened outward in the radial direction of the tire.

Moreover, it the carcass ply cord is extended at a certain inclination angle with respect to the meridional direction of the tire, the joints similar to those of the belt layer as mentioned below are formed in the carcass ply

In general, the cords of the belt layer are extended at a relatively small angle with respect to the equatorial plane of the tire, for example, at an angle of 10-40° crossing therewith, while a raw material for the belt layer of a given width formed by covering a plurality of belt layer cords arranged side by side with rubber becomes continuous in the extending direction of the cord. Therefore, the joints of the belt layer formed by butt-joining the raw material for the belt layer on a periphery are frequently and continuously extended at a certain inclination angle corresponding to the above angle with respect to the meridian of the tire.

In each of the innerliner and the carcass ply, irrespective of extending the joints in the meridional direction, it is preferable that the interval between the joints in the radially inner end portion is made approximately equal to a size obtained by multiplying or dividing a peripheral length of a circle having a diameter of 1 inch by an integral number. In this case, the mutual joints in each of the innerliner and the carcass ply can be always positioned at equal intervals in the peripheral direction even in tires having any sizes.

That is, the size such as rim size of a wheel rim to be mounted with the tire or the like is specified by inch as a unit, while the radially inner end portion of each of the innerliner and the carcass ply has a peripheral length substantially corresponding to the peripheral length of the rim size, so that the interval between the joints in such a portion of each of the innerliner and the carcass ply is made approximately equal to the size obtained by multiplying or dividing a standard peripheral length by an integral number when a peripheral length of a circle having a diameter of 1 inch is standard, whereby the interval between the mutual joints can be always kept constant in the peripheral direction irrespectively of the size of an approved rim.

It is preferable that the joints in each of the bead filler rubber and the side rubber are spirally extended in the radial direction of the tire and the joints in the tread rubber are helically extended in the widthwise direction of the tire. In this case, one end and the other end of the spirally or helically continuing joint are positioned opposite to each other in, for example, the diameter direction of the tire, whereby the joint portion extending in the meridional direction of the tire can be effectively eliminated and the lowering of the uniformity and the balance in the product tire can be sufficiently prevented.

Moreover, the joints in the tread rubber can be continuously formed from one side part to the other side part in the widthwise direction of the tire, or can be continuously formed from each side part in the widthwise direction of the tire to a central part in the widthwise direction of the tire. In the former case, the joint portion extending from the tread rubber in the meridional direction of the tire can be effectively eliminated. In the latter case, the symmetry of the joints in the tread rubber and hence the wind-laminated state of the tread rubber material with respect to the equatorial plane of the tire can be more enhanced.

If it is intended to more improve the tire performances by constituting the tread rubber with a base rubber located at an inner layer side and a cap rubber located at an outer layer side, it is preferable that mutually independent joints arranged in intervals in a direction along an outer profile at the meridional section of the tire and extending substantially in the peripheral direction are formed in each of the base rubber and the cap rubber for clearly dividing the base rubber and the cap rubber to sufficiently develop the function of each rubber as is expected.

When the tread rubber includes a high electrically conductive rubber existing in a middle portion in the widthwise direction of the tire and continuing over a full thickness in the radial direction of the tire, it is preferable to provide the high electrically conductive rubber with helically and spirally formed joints distancing in a direction along an outer profile at the meridional section of the tire and in the radial direction of the tire and extending substantially in the peripheral direction.

When the joints are formed in the high electrically conductive rubber as mentioned above, the high electrically conductive rubber can be strongly bonded to the adjacent tread rubber portion made of different material over sufficiently large area and the durability against accidental peeling trouble or the like of the tread rubber can be enhanced.

When a belt reinforcing layer including cord(s) extending substantially in the peripheral direction and covering the belt over a full width thereof is arranged between the belt and the tread rubber, it is preferable that joints extending substantially in the peripheral direction at given intervals in a direction along an outer profile at the meridional section of the tire are arranged in the belt reinforcing layer, for example, by helically winding and joining a ribbon for the reinforcing layer, which is formed by coating plural aligned cords with rubber, in the widthwise direction of the tire.

In this case, the joint portion extending in the meridional direction of the tire can be eliminated as far as possible likewise the aforementioned joints in each of the tread rubber, the bead filler rubber and the side rubber to more effectively improve the uniformity and the balance of the tire.

When a squeegee rubber layer is arranged on at least one of an inner face side and an outer face side of the carcass ply, or when a belt under cushion rubber is arranged on a side portion of the belt and at its inner face side, or when a tread under cushion rubber is arranged at an inner face side of the tread rubber, or when a chafer rubber is arranged on a side of the bead portion at least contacting with a rim flange, it is preferable that joints extending substantially in the peripheral direction at intervals in a direction along the outer profile at the meridional section of the tire are arranged in the squeegee rubber layer, the belt under cushion rubber, the tread under cushion rubber or the chafer rubber due to the same reasons as mentioned above. Also, when a side reinforcing layer including cords extending substantially in the peripheral direction of the tire is arranged at an inner face side of the side rubber, it is preferable that the side reinforcing layer is provided with joints extending substantially in the peripheral direction at intervals in a direction along the outer profile at the meridional section of the tire due to the same reasons.

### BRIEF DESCRIPTION OF THE DRAWINGS

FIG. 1 is a partial perspective view partly shown in section of an embodiment of the invention.

FIG. 2 is a view illustrating an arrangement of an insert reinforcing layer and a flipper.

FIG. 3 is a sectionally perspective view illustrating an arrangement of a side reinforcing rubber.

FIG. 4 is a sectionally perspective view illustrating another arrangement of a side reinforcing rubber.

FIG. 5 is a view illustrating an example of the invention.

### BEST MODE FOR CARRYING OUT THE INVENTION

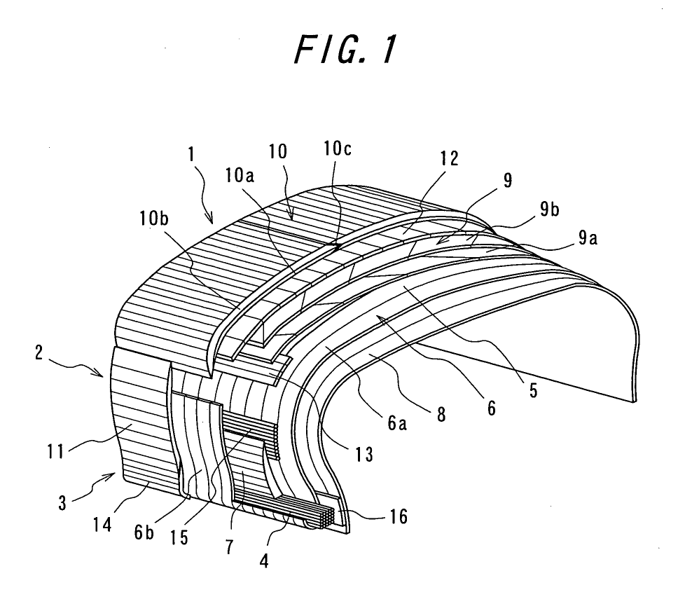

In an embodiment of the invention shown in FIG. 1, numeral 1 is a tread portion, numeral 2 a sidewall portion continuously extending inward from each side edge of the tread portion 1 in a radial direction, and numeral 3 a bead portion continuing from an inner peripheral side of the sidewall portion 2.

Between bead cores 4 arranged in the respective bead portions 3 is toroidally extended one or more carcass plies, one carcass ply 5 in the illustrated embodiment, and each side portion thereof is wound around the bead core 4 outward in the radial direction to constitute a carcass, a radial carcass 6 in this embodiment. A bead filler rubber 7 is arranged between a main body portion 6a and a turnup portion 6b of the radial carcass 6 on an outer peripheral side of the bead core 4.

Also, an innerliner 8 is arranged on an inner face side of the radial carcass 6, while a belt 9 comprised of one or more layers, two belt layers 9a, 9b in the illustrated embodiment is arranged on an outer peripheral side of a crown portion of the radial carcass 6. Furthermore, a tread rubber 10 forming a treading face is arranged on an outer peripheral side of the belt 9, while a side rubber 11 forming a sidewall of the tire is arranged on an outer face side of a side portion of the radial carcass 6.

In the illustrated embodiment, a belt reinforcing layer 12 including, for example, organic fiber cords extending substantially in a peripheral direction and covering the belt 9 over a full width thereof is further arranged between the belt 9 and the tread rubber 10, and a belt under cushion rubber 13 is arranged on each side portion of the belt 9 between the belt 9 and the radial carcass 6, and a chafer rubber 14 is arranged on a side of the bead portion 13 at least contacting with a rim flange, and a side reinforcing layer 15 including cords extending substantially in the peripheral direction is arranged on an inner face side of the side rubber 11 between the main body portion 6a and the turnup portion 6b of the radial carcass 6 and the bead filler rubber 7.

In the figure, numeral 16 is a canvas chafer arranged between the innerliner 8 and the radial carcass 6 in the vicinity of the bead core 4.

In the tire having such constitutional members, the tread rubber 10 is further constructed with a base rubber 10a located at an inner layer side and a cap rubber 10b located at an outer layer side and further a high electrically conductive rubber 10c existing in a widthwise middle portion of the treading face and continuing over a full thickness of the tread rubber 10 in a radial direction of the tire.

In the invention, plural joints positioned at approximately constant intervals in the peripheral direction and formed through butt joining, overlap joining or the like as shown by a thin line in the figure are arranged in each of the innerliner 8, the carcass ply 5 and the belt layers 9a, 9b. The interval between the joints continuously extending substantially in the meridional direction of the tire in each of the innerliner 8 and the carcass ply 5 is made an equal interval at an inner end part in the radial direction thereof substantially corresponding to a size obtained by multiplying or dividing a peripheral length of a circle having a diameter of 1 inch by an integral number.

On the other hand, the plural joints in the belt layers 9a, 9b are generally extended at a given inclination angle with respect to the meridian of the tire in connection with the required extending angle of the cord in the belt layer with respect to an equatorial plane of the tire.

In each of the tread rubber 10, the bead filler rubber 7 and the side rubber 11 are arranged joints continuing substantially in the peripheral direction, which are positioned at intervals in a direction along an outer profile at the meridional section of the tire. That is, the joints are positioned at intervals in the widthwise direction of the tire in case of the tread rubber 10, and at intervals in the radial direction of the tire in case of the bead filler rubber 7 and the side rubber 11.

In this case, each of the joints continuing in the peripheral direction is preferable to be formed continuously or near to continuity as far as possible from one side to the other side in the widthwise direction of the tire or from an inner edge to an outer edge in the radial direction of the tire in each of the rubbers 10, 7 and 11 in order to avoid the formation of separate joints having an extending component in the meridional direction of the tire, which becomes a factor of lowering the uniformity and the balance of the tire, as far as possible. For this end, it is preferable that the joints in the tread rubber 10 are helically extended in the widthwise direction of the tire, and the joints in each of the bead filler rubber 7 and the side rubber 11 are spirally extended in the radial direction of the tire.

The joints in the tread rubber 10 are more preferable to be continued from one side part to the other side part in the widthwise direction of the tire without interruption. When the tread rubber 10 having a thick thickness is formed by helically winding a narrow-width rubber ribbon, in order to prevent a fear in the winding of the rubber ribbon such as accidental winding break, change of winding posture or the like and hence a disruption of balance between tire portions of a product tire with respect to the equatorial plane due to the winding break or the like, it is preferable that the rubber ribbon is helically wound from each side part in the widthwise direction of the tire to a widthwise central part, whereby helically extending joints of the tread rubber 10 are disrupted in the widthwise central part of the tread once. This is true in case that the tread rubber 10 is constituted with base rubber 10a and the cap rubber 10b or is further added with the high electrically conductive rubber 10c.

That is, each of the base rubber 10a and the cap rubber 10b can be formed en suite with continuing the joints from one side part to the other side part, or may be formed with interruption at the central part in the widthwise direction of the tread once.

Moreover, when the high electrically conductive rubber 10c is further arranged, it is required that the joints are discontinued at the middle part in the widthwise direction of the tread once irrespectively of the tread rubber 10 having a two layer structure of base rubber 10a and cap rubber 10b and a starting material of the high electrically conductive rubber is wound and laminated adjacent to such a discontinued portion. In this case, the joints of the high electrically conductive rubber 10c are preferable to be positioned at intervals in the widthwise direction and the radial direction of the tire, respectively, and extended en suite substantially in the peripheral direction.

These facts are also true in the belt under cushion rubber 13, the chafer rubber 14, the tread under cushion rubber arranged at an inner face side of the tread rubber 10 and not shown, and the like. Also, the joints of these rubbers are positioned at intervals in a direction along an outer profile at the meridional section of the tire and continuously extended substantially in the peripheral direction, whereby the excellent uniformity and balance of a product tire can be advantageously guaranteed while eliminating the formation of joints having an extending component in the meridional direction of the tire as far as possible.

Further, it is preferable that the joints positioned at intervals in the widthwise direction of the tire and continuously extending substantially in the peripheral direction are formed en suite in the belt reinforcing layer 12 by helically and continuously winding a reinforcing ribbon made by covering a plurality of aligned cords with rubber from one side part to the other side part in the widthwise direction of the tire, and the joints positioned at intervals in the radial direction of the tire and continuously extending substantially in the peripheral direction are formed en suite in the side reinforcing layer 15 by spirally winding a reinforcing ribbon made by covering a plurality of aligned cords with rubber from an inner peripheral side to an outer peripheral side or in a direction opposite thereto at a given zone in the radial direction from the same reasons as mentioned above.

Moreover, the side reinforcing layer 15 may be arranged at an outer face side of the bead filler rubber 7 or at an outer face side of the turnup portion 6b of the radial carcass 6 or an outward side of the turnup portion 6b in the radial direction instead of the illustrated embodiment.

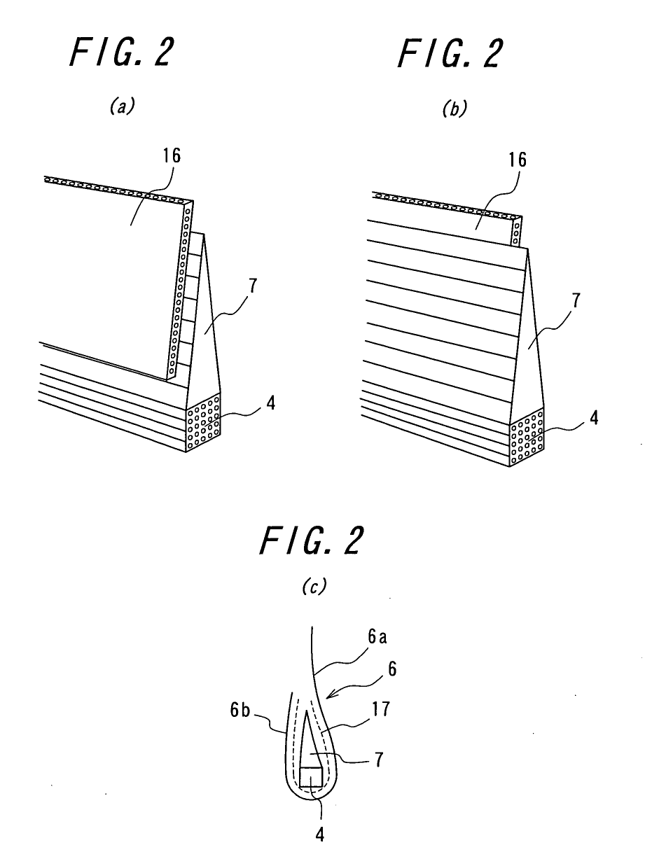

Instead of or in addition to the above side reinforcing layer, an insert reinforcing layer 16 in which organic fiber cords or steel cords are extended at an inclination angle of 30-70° with respect to the meridian of the tire may be arranged at an outer face side or an inner face side of the bead filler rubber 7 as shown in FIGS. 2(a), (b). Further, a flipper 17 enveloping the bead core 4 and the bead filler rubber 7 with the same extending organic fiber cords such as nylon cords may be arranged as shown by a schematically section view in FIG. 2(c).

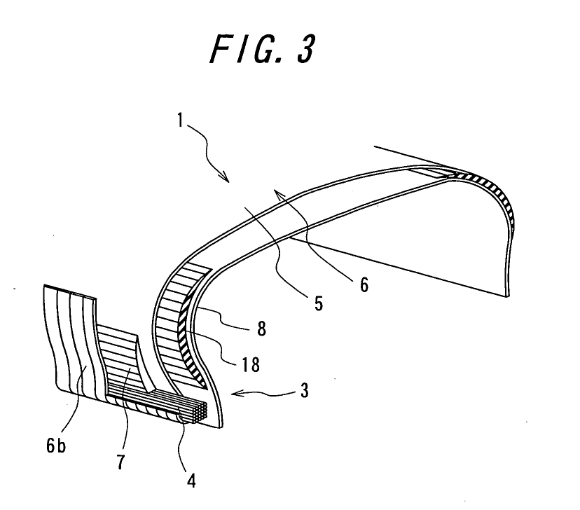

FIG. 3 is a view illustrating another embodiment, in which a side reinforcing rubber 18 having substantially a crescent shape at the meridional section of the tire is arranged at a region, for example, from the bead portion 3 to the tread portion 1 in the side portion of the tire between the inner liner 8 and the carcass ply 5, and also joints through butt joining, overlap joining or the like are arranged in the side reinforcing rubber 18 so as to position at intervals in a direction along the outer profile at the meridional section of the tire and extend substantially in the peripheral direction. In this case, joints extending in the meridional direction of the tire can be advantageously eliminated from the side reinforcing rubber 18, which can guarantee the improvement of the uniformity and the mass balance.

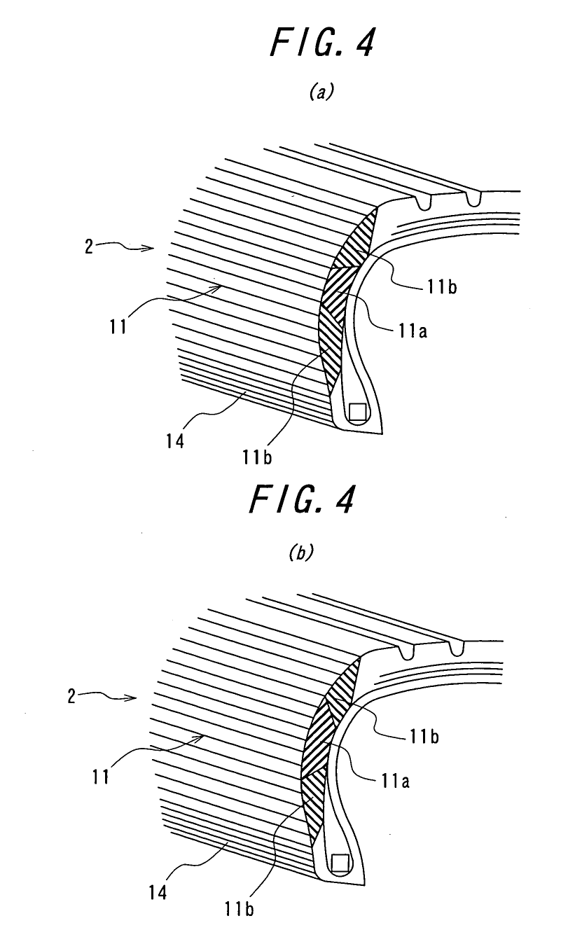

FIG. 4 shows a case that the side rubber is constituted with two kinds of black rubber and white rubber.

In this case, the joints positioned at intervals in a direction along the outer profile at the meridional section of the tire and extending substantially in the peripheral direction are formed spirally in the radial direction in each of white rubber 11a arranged in a middle part of the sidewall portion 2 and black rubbers 11b arranged adjacent to inner and outer sides of the white rubber 11a in the radial direction.

Thus, joints extending in the meridional direction can also be effectively eliminated from the side rubber 11.

Also, a border line between the white rubber 11a and the black rubber 11b extends in a direction that a width of the white rubber 11a in the radial direction of the tire gradually narrows toward the outer surface side of the side rubber 11 as shown in FIG. 4(a) when the white rubber 11a is first arranged and thereafter the black rubber 11b is arranged, and extends in a direction that the width gradually widens toward the outer surface side of the side rubber 11 as shown in FIG. 4(b) when the white rubber 11a is arranged afterward.

Moreover, when the white rubber 11a is not required to have comparatively a thickness though it is not shown, it is possible to arrange the white rubber so as to overlap with a given region of an outer surface of the side rubber formed as shown in FIG. 1.

### EXAMPLES

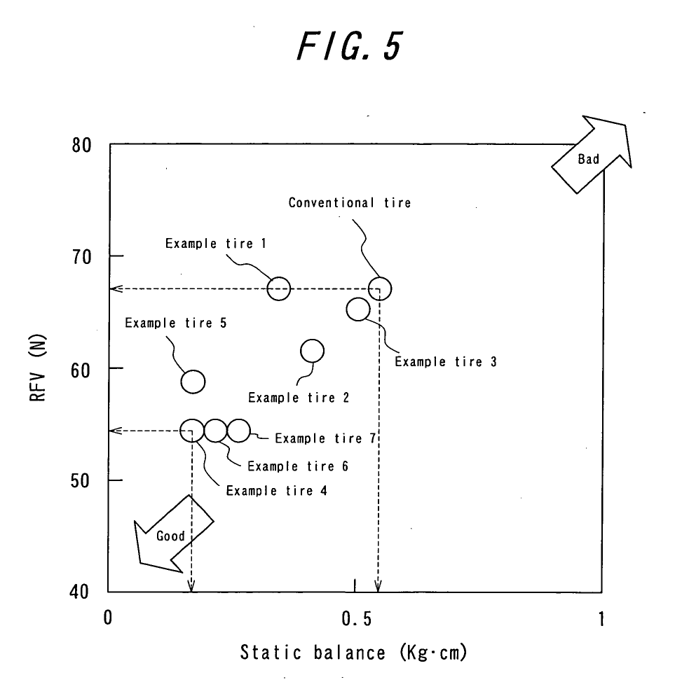

There are provided example tires having a structure according to the invention and a tire size of 235/45 ZR17 in which joints positioned at approximately constant intervals in the peripheral direction are arranged in at least one of the innerliner, the carcass ply and the belt layer and joints positioned at intervals in a direction along an outer profile at the meridional section of the tire and continuously extending substantially in the peripheral direction are formed in each of the tread rubber, the bead filler rubber and the side rubber, and a radial force variation (hereinafter referred to as RFV) is measured as an indication of the uniformity and a static balance is measured as an indication of the balance to obtain results shown in FIG. 5.

Moreover, the static balance is determined by setting the tire onto a balancer and attaching a weight to a side portion corresponding to a light point position of the tire so as to render an unbalance quantity into zero to measure a balance as a product of mass of the weight (kg) and a distance from a center of the balance to the attaching position of the weight (cm).

The conventional tire in FIG. 5 is a tire built on a building drum according to the building method described in the conventional technique in which each of the innerliner, the carcass ply, the bead filler rubber, the side rubber and the base rubber and cap rubber of the tread rubber has a joint formed at one place in the peripheral direction through overlap joining and extending substantially in the meridional direction of the tire and continuing over a full peripheral length thereof and also each of the belt layers has joints extending at a given inclination angle with respect to the meridian of the tire and the same joint extending at one place in the peripheral direction and substantially in the meridional direction and formed through the overlap joining.

In the example tire 1, 17 joints positioned at approximately equal intervals in the peripheral direction and extending in the meridional direction of the tire are arranged in only the innerliner and the same joints as in the conventional tire are arranged in each of the carcass ply and the belt layer. In the example tire 2, 17 joints extending in the meridional direction of the tire are arranged in only the carcass ply and each of the innerliner and belt layer has the same structure as in the conventional tire. In the example tire 3, 22 joints extending obliquely with respect to the meridional direction of the tire are arranged in only the belt layer and the same joints as in the conventional tire are arranged in each of the innerliner and carcass ply.

The example tire 4 has a structure shown in FIG. 1, and the example tire 5 has a structure of FIG. 1 added with the side reinforcing rubber shown in FIG. 3, and the example tire 6 has a structure of FIG. 1 provided with the insert reinforcing layer shown in FIG. 2(a) instead of the side reinforcing layer, and the example tire 7 is different from the example tire 4 in only a point that the side rubber is constituted with white rubber and black rubber as shown in FIG. 4(a).

According to FIG. 5 showing the results measured every 100 tires, it is clear that the example tires, particularly example tires 4-7 can advantageously improve both of RFV and static balance as compared with the conventional tire.

### INDUSTRIAL APPLICABILITY

According to the invention, plural joints positioned at approximately equal intervals in the peripheral direction are equally dispersed and arranged in at least one of the innerliner, the carcass ply and the belt layer to enhance the homogeneity of the tire in the peripheral direction, and further joints positioned at intervals in a direction along the outer profile at the meridional section of the tire and continuously extending substantially in the peripheral direction are arranged in at least one of the tread rubber, the bead filler rubber and the side rubber to eliminate the formation of joints having an extending component in the meridional direction of the tire as far as possible and prevent the lowering of various balances, whereby the uniformity and the balance in the tire can be largely improved as compared with the conventional tire built on the building drum.

1. A pneumatic tire comprising a carcass comprised of one or more carcass plies toroidally extending between a pair of bead cores and wound at a side portion thereof around the bead core outward in a radial direction, a bead filler rubber arranged at an outer peripheral side of the bead core between a main body portion and a turnup portion of the carcass, an innerliner arranged at an inner face side of the carcass, a belt arranged on an outer peripheral side of a crown portion of the carcass and comprised of one or more belt layers, a tread rubber arranged on an outer peripheral side of the belt to form a treading face, a side rubber arranged on an outer face side of a side portion of the carcass to form a sidewall of the tire, in which at least one of the innerliner, the carcass ply and the belt layer is provided with joints positioned at approximately constant intervals in a peripheral direction, and at least one of the tread rubber, the bead filler rubber and the side rubber is provided with joints positioned at intervals in a direction along an outer profile at a meridional section of the tire and extending substantially in the peripheral direction.

2. A pneumatic tire according to claim 1, wherein each of the innerliner, the carcass ply and the belt layer is provided with the joints positioned at approximately constant intervals in the peripheral direction.

3. A pneumatic tire according to claim 1, wherein each of the tread rubber, the bead filler rubber and the side rubber is provided with the joints positioned at intervals in the direction along the outer profile at the meridional section of the tire and extending substantially in the peripheral direction.

4. A pneumatic tire according to claim 1, wherein the joints in each of the innerliner and the carcass ply is continuous substantially in the meridional direction of the tire.

5. A pneumatic tire according to claim 1, wherein the joints in the belt layer are continuous at a constant inclination angle with respect to the meridian of the tire.

6. A pneumatic tire according to claim 1, wherein the interval between the joints in a radially inner end portion of each of the innerliner and the carcass ply is made approximately equal t a size obtained by multiplying or dividing a peripheral length of a circle having a diameter of 1 inch by an integral number.

7. A pneumatic tire according to claim 1, wherein the joints in each of the bead filler rubber and the side rubber are spirally extended in the radial direction of the tire.

8. A pneumatic tire according to claim 1, wherein the joints in the tread rubber are helically extended in the widthwise direction of the tire.

9. A pneumatic tire according to claim 8, wherein the joints in the tread rubber are continuous from one side part to the other side part in the widthwise direction of the tire.

10. A pneumatic tire according to claim 8, wherein the joints in the tread rubber are continuous from each side part in the widthwise direction of the tire to a central part in the widthwise direction of the tire.

11. A pneumatic tire according to claim 1, wherein the tread rubber is constituted with a base rubber located at an inner layer side and a cap rubber located at an outer layer side, and the joints extending substantially in the peripheral direction are independently arranged in the base rubber and the cap rubber, respectively.

12. A pneumatic tire according to claim 1, wherein the tread rubber is provided at a middle part in the widthwise direction of the tire with a high electrically conductive rubber continuing over a full thickness in the radial direction of the tire, and joints extending substantially in the peripheral direction at intervals in the radial direction of the tire are arranged in the high electrically conductive rubber.

13. A pneumatic tire according to claim 1, wherein a belt reinforcing layer containing cord(s) extending substantially in the peripheral direction is arranged between the belt and the tread rubber, and joints positioned at intervals in a direction along the outer profile of the tire and extending substantially in the peripheral direction are arranged in the belt reinforcing layer.

14. A pneumatic tire according to claim 1, wherein a squeegee rubber layer is arranged on at least one of the inner face side and the outer face side of the carcass ply, and joints extending substantially in the peripheral direction at intervals in a direction along the outer profile in the meridional section of the tire are formed in the squeegee rubber layer.

15. A pneumatic tire according to claim 1, wherein a belt under cushion rubber is arranged on a side portion of the belt and at its inner face side, and joints extending substantially in the peripheral direction at intervals in a direction along the outer profile in the meridional section of the tire are formed in the belt under cushion rubber.

16. A pneumatic tire according to claim 1, wherein a tread under cushion rubber is arranged at an inner face side of the tread rubber, and joints extending substantially in the peripheral direction at intervals in a direction along the outer profile in the meridional section of the tire are formed in the tread under cushion rubber.

17. A pneumatic tire according to claim 1, wherein a chafer rubber is arranged on a site of the bead portion at least contacting with a rim flange, and joints extending substantially in the peripheral direction at intervals in a direction along the outer profile in the meridional section of the tire are formed in the chafer rubber.

18. A pneumatic tire according to claim 1, wherein a side reinforcing layer including cords extending substantially in the peripheral direction of the tire is arranged at an inner face side of the side rubber, and joints extending substantially in the peripheral direction at intervals in a direction along the outer profile in the meridional section of the tire are arranged in the side reinforcing layer.

19. A pneumatic tire according to claim 1, wherein a side reinforcing rubber arranged at a side portion of the tire between the innerliner and the carcass ply and having substantially a crescent shape at the meridional section of the tire is provided with joints positioned at intervals in the direction along the outer profile and extending substantially in the peripheral direction.
